(19) United States
(12) Patent Application Publication
(10) Pub. No.: US 2025/0287380 A1
(43) Pub. Date: Sep. 11, 2025

(54) UPLINK CONTROL INFORMATION MULTIPLEXING ON A PHYSICAL UPLINK CONTROL CHANNEL

(71) Applicant: Apple Inc., Cupertino, CA (US)

(72) Inventors: Yushu Zhang, Beijing (CN); Chunxuan Ye, San Diego, CA (US); Weidong Yang, San Diego, CA (US); Dawei Zhang, Saratoga, CA (US); Seyed Ali Akbar Fakoorian, San Diego, CA (US); Haitong Sun, Cupertino, CA (US); Wei Zeng, Saratoga, CA (US); Hong He, San Jose, CA (US); Chunhai Yao, Beijing (CN)

(21) Appl. No.: 18/858,652

(22) PCT Filed: Apr. 28, 2022
(86) PCT No.: PCT/CN2022/089841

§ 371 Date: Oct. 21, 2024

(51) Int. Cl. H04W 72/21; H04W 52/36

(52) U.S. Cl. CPC H04W 72/21; H04W 52/367

(57) ABSTRACT

A user equipment (UE) includes a set of multiple antenna panels and a processor. The processor is configured to identify a time domain overlap between, at least, a first physical uplink control channel (PUCCH) to be transmitted from a first antenna panel of the set of multiple antenna panels and a second PUCCH to be transmitted from a second antenna panel of the set of multiple antenna panels. The first PUCCH is intended to carry a first uplink control information (UCI), and the second PUCCH is intended to carry a second UCI. The processor is further configured to determine whether to transmit one or both of the first UCI or the second UCI, in at least one of the first PUCCH or the second PUCCH. The determination is made at least partly based on a PUCCH collision handling rule for multiple antenna panels.

### TECHNICAL FIELD

This application relates generally to wireless communication systems, including methods and implementations for multiplexing uplink control information (UCI) on a physical uplink control channel (PUCCH), dropping UCI, or transmitting PUCCHs from each of multiple antenna panels.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example of UCI multiplexing within a PUCCH.

FIG. 2 shows an example method of wireless communication by a UE, which method may be used to determine and transmit a beam-to-panel mapping to a 3GPP network (e.g., to a base station).

FIG. 3 shows an example method of wireless communication by a base station, which method may be used to configure and/or receive a beam-to-panel mapping from a UE.

FIG. 4 shows an example method of wireless communication by a UE, which method may be used to transmit UCI in accord with a PUCCH collision handling rule for multiple antenna panels.

FIG. 5 shows an example method of wireless communication by a UE, which method may be used to transmit UCI in accord with a PUCCH collision handling rule for multiple antenna panels.

FIG. 6 shows an example application of the method shown in FIG. 5.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

A UE can transmit multiple UCIs in PUCCH, depending on the PUCCH format. In 3GPP Release 15 (Rel-15), several PUCCH formats are supported for reporting UCI. See, 3GPP technical specification (TS) 38.213 § 9.2.2. Different types of information can be transmitted in different PUCCHs using the different formats. Formats 0 and 2, for example, are short PUCCHs that only span 1 or 2 symbols. Format 0 can only be used to transmit 1 or 2 bits of information. Format 2 can also be used to transmit 1 or 2 bits of information, or can be used to transmit more information by increasing the number of resource blocks (RBs) in which it is transmitted. Formats 1, 3, and 4 are long PUCCHs, and can be transmitted over four or more symbols. Additional characteristics of the various PUCCH formats are as follows.

A PUCCH format 0 (short PUCCH) transmission is over 1 symbol or 2 symbols and 1 RB. The number of supported hybrid automatic repeat request (HARQ) acknowledgement (ACK) (HARQ-ACK) information bits with positive or negative scheduling request (SR) bits (HARQ-ACK/SR bits) is 1 or 2.

A PUCCH format 1 (long PUCCH) transmission is over 4 or more symbols and 1 RB. The number of supported HARQ-ACK/SR bits is 1 or 2.

A PUCCH format 2 (short PUCCH) transmission is over 1 symbol or 2 symbols and 1-16 RBs. The number of UCI bits that can be transmitted is more than 2.

A PUCCH format 3 (long PUCCH) transmission is over 4 or more symbols and 1-16 RBs, except for 7, 11, 13, and 14 RBs. The number of UCI bits that can be transmitted is more than 2.

A PUCCH format 4 (long PUCCH) transmission is over 4 or more symbols and 1 RB. The number of UCI bits that can be transmitted is more than 2.

The following three types of UCI are supported in 3GPP Rel-15: SR, HARQ-ACK, and CSI (including beam reports that are considered as a type of CSI, such as Layer 1 reference signal received power (L1-RSRP) and Layer 1 signal to interference and noise ratio (L1-SINR) reports.

A PUCCH can be transmitted with a single repetition or multiple repetitions in the time domain, across multiple sub-slots or slots.

If two PUCCHs with single repetitions overlap, the UCIs from the two PUCCHs may be multiplexed and transmitted in a single PUCCH. For HARQ-ACK+N configured SRs on PUCCH format 2/3/4, X bits may be appended to the end of the HARQ-ACK to indicate the presence of SR(s), where X=ceil(log2(K+1)). For HARQ-ACK, with or without SR but with CSI, if the UE is configured with the RRC parameter simultaneousHARQ-ACK-CSI, the UE multiplexes downlink (DL) HARQ-ACK information, with or without SR, and CSI report(s), from corresponding PUCCHs, within a same PUCCH, depending on the total payload size. A base station may configure more than one PUCCH resource set, with different payload sizes. Otherwise, if the radio resource control (RRC) parameter simultaneousHARQ-ACK-CSI is disabled, the UE only reports one UCI, prioritizes HARQ, drops the CSI report(s), and only includes DL HARQ-ACK information in UCI, with or without SR, in the PUCCH.

If two PUCCHs overlap have a time domain overlap and at least one of the PUCCHs is configured with more than one repetition, UCI multiplexing is not allowed, and the UE only reports the UCI with higher priority, which can be determined by the UCI types. For example, HARQ-ACK>SR>CSI.

For UCI multiplexing, the multiplexed UCI should follow a timeline requirement. For example, the PUCCH that will include the multiplexed UCI should meet the minimum delay requirement for HARQ-ACK feedback and CSI processing (e.g., the starting point for both PUCCH should meet the minimal delay requirement, and a scheduler should avoid cases that do not.

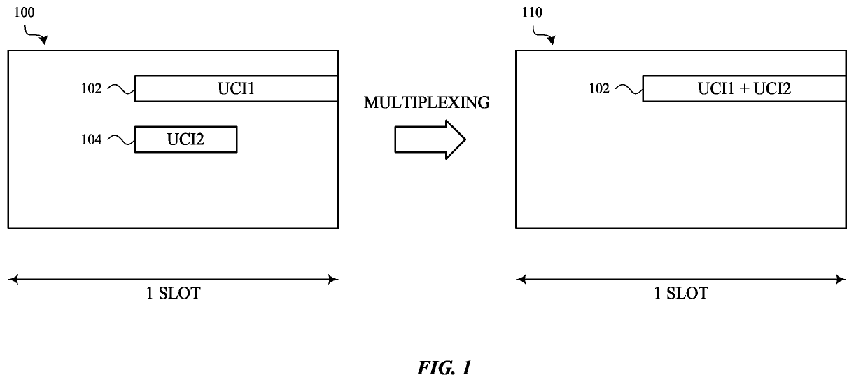

FIG. 1 shows an example of UCI multiplexing within a PUCCH. In the slot of resources 100 shown on the left, a first PUCCH 102 is intended to be transmitted with a first UCI, and a second PUCCH 104 is intended to be transmitted with a second UCI. Because the first and second PUCCHs 102, 104 have the same starting point in time, and if the payload size of the first PUCCH 102 supports multiplexing of the first and second UCIs, the first and second UCIs may be multiplexed in the first PUCCH 102, as shown in the slot of resources 110 on the right, and the second PUCCH 104 need not be transmitted.

The above cases for multiplexing or dropping PUCCH are based on single antenna panel transmissions or antenna panel selection transmissions (i.e., scenarios in which only one antenna panel is selected and used for transmission). For a UE capable of multiple antenna panel transmissions, the existing multiplexing/dropping rules need to be enhanced, since a UE capable of multiple antenna panel transmissions may be able to transmit more than one PUCCH at the same time (e.g., one PUCCH from each antenna panel).

For a UE capable of multiple antenna panel transmissions, one issue is how to maintain a common understanding between a 3GPP network (e.g., a base station) and a UE on which antenna panels are transmitting which PUCCHs. Another issue is how a UE capable of multiple antenna panel transmissions handles the multiplexing/dropping of PUCCHs when two PUCCHs have a time domain overlap.

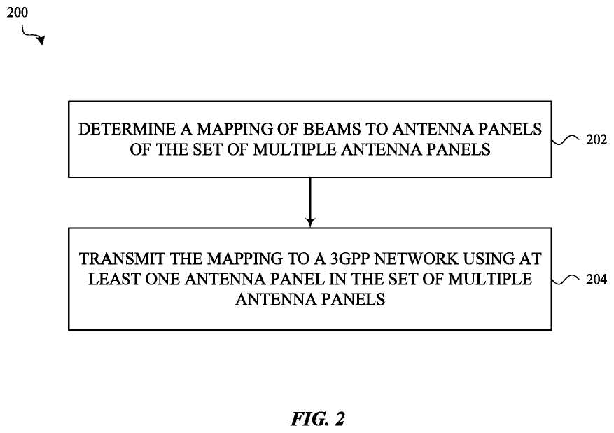

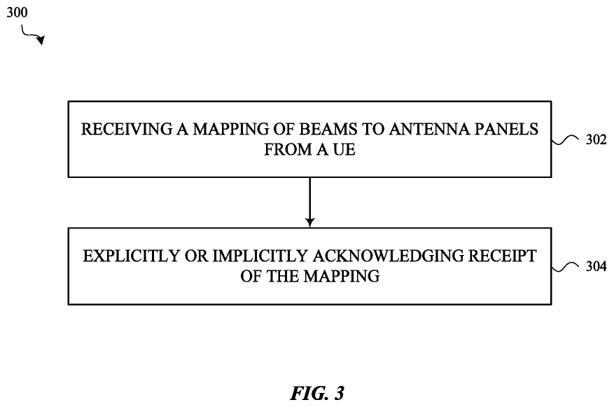

So that a base station and UE may maintain the same understanding regarding antenna panels used for uplink (UL) transmissions (e.g., PUCCH transmissions), the methods described with reference to FIGS. 2 and 3 are provided.

FIG. 2 shows an example method 200 of wireless communication by a UE, which method 200 may be used to determine and transmit a beam-to-panel mapping to a 3GPP network (e.g., to a base station). The method 200 may be performed by a processor of the UE, and transmissions and receptions initiated by the processor may be made using a set of multiple antenna panels of the UE.

At 202, the method 200 may include determining a mapping of beams to antenna panels of the set of multiple antenna panels.

At 204, the method 200 may include transmitting the mapping to a 3GPP network using at least one antenna panel in the set of multiple antenna panels.

In accord with a first set of embodiments, the method 200 may include receiving, from the 3GPP network and via at least one antenna panel in the set of multiple antenna panels, a configuration to report an antenna panel identifier for a respective antenna panel, of the set of multiple antenna panels, used for each of one or more beams or groups of beams. The one or more beams or groups of beams may include beams that are used for a set of configured synchronization signal block (SSB) and/or channel state information reference signal (CSI-RS) resources. The set of SSB and/or CSI-RS resources may be configured by higher layer signaling (e.g., RRC signaling). In these embodiments, the mapping of beams to antenna panels may include the antenna panel identifier for the respective antenna panel used by the UE for each of the one or more beams or groups of beams.

In accord with the first set of embodiments of the method 200, the UE may include, in the mapping of beams to antenna panels, an antenna panel identifier (e.g., a panel entity index) for each of the one or more beams or groups of beams. In the case of individual beams, the beams may be identified by an SSB resource indicator (SSBRI) or a CSI-RS resource indicator (CRI). In the case of groups of beams, each group may be identified by a beam group index (e.g., a channel measurement resource (CMR) set index).

In addition to the mapping of beams to antenna panels, the UE may be configured to report a L1-RSRP, L1-SINR, and/or power headroom (PHR) for each of the beam(s) identified in the configuration received from the 3GPP network.

In some cases, the mapping of beams to antenna panels (e.g., antenna panel identifiers) may be transmitted in UCI carried by a PUCCH or physical uplink shared channel (PUSCH), or in a medium access control (MAC) control element (CE) (MAC CE).

In some cases, the UE can report a maximum number of antenna panels as a UE capability, so that the 3GPP network (e.g., a base station) may determine a payload size for the UE to report an antenna panel identifier.

The UE should use the reported antenna panel when the corresponding SSB/CSI-RS, or a downlink reference signal QCLed with the SSB/CSI-RS, is indicated as the source reference signal for a transmission configuration indicator (TCI) state. The UE should use the reported antenna panel for K milliseconds (ms) after it transmits a mapping, or for K ms after the UE receives an acknowledgement (ACK) for transmitting a mapping (i.e., the UE should use the mapping for K ms before it changes its mapping). A value for K can be predefined, or configured by higher layer signaling, or reported by the UE as a UE capability. After K ms (i.e., an effective window for the mapping), the mapping can be assumed to be unknown by the 3GPP network (e.g., by a base station), or a new mapping may be based on a default or predefined mapping (e.g., an antenna panel with a lowest or particular antenna panel identifier), or a new mapping may be transmitted to the 3GPP network (e.g., to a base station) by the UE. The ACK for a mapping can be based on a physical downlink control channel (PDCCH), or on a TCI indication that is based on a reported mapping (i.e., if a TCI indication aligns with a reported mapping of a beam to an antenna panel, the UE can assume the TCI indication is an ACK), or on a predefined rule (e.g., a rule specifying that, if the UE has not been triggered to transmit a new mapping within X ms after transmitting a mapping, the transmitted mapping is assumed to be acknowledged).

In accord with a second set of embodiments, the method 200 may include in the mapping an antenna panel identifier for a respective antenna panel used by the UE for each of one or more activated TCI states or each of one or more indicated TCI states. In these embodiments, the mapping of beams to antenna panels may include the antenna panel identifier for the respective antenna panel used by the UE for each of the one or more activated TCI states or each of the one or more indicated TCI states.

In accord with the second set of embodiments of the method 200, the mapping of beams to antenna panels (e.g., antenna panel identifiers) may be transmitted in UCI carried by a PUCCH or PUSCH, or in a MAC CE. In some cases, the UE's transmission of the mapping may be triggered by the 3GPP network (e.g., by a base station). For example, the transmission may be triggered by TCI activation/indication signaling, or by other downlink control information (DCI), a MAC CE, or RRC signaling for an aperiodic, semi-persistent, or periodic report. In other cases, the UE's transmission may be self-triggered. For example, the UE can transmit the mapping 1) when a report prohibit timer expires and a current mapping is different from a previously reported mapping, or 2) when a change in mapping would lead to a different or incorrect status during simultaneous UL transmissions. As used herein, simultaneous transmissions may include, but are not limited to, transmissions which occur at the same time and/or transmissions which occur in a substantially contemporaneous manner. These conditions, or others, may be useful to prevent the UE from transmitting a new mapping too often.

In some cases, the UE may explicitly indicate, in a mapping, both a TCI index and an antenna panel identifier index. In some cases, the UE may explicitly indicate, in a mapping, an antenna panel identifier for each activated TCI index. In some cases, the UE may implicitly indicate an antenna panel identifier, by means of the PUCCH it selects to transmit an ACK for an activated TCI or indicated TCI.

For both the first and second sets of embodiments of the method 200, a logical index (e.g., a set index or a beam group index) may be used as an antenna panel identifier instead of a panel entity index.

The maximum number of active antenna panels and the maximum number of physical antenna panels may differ for the UE. If so, the UE may report an identifier of an active antenna panel instead of an identifier of a physical antenna panel.

For beam failure recovery (BFR), the UE can report an antenna panel identifier in a beam failure recovery request (BFRQ). The antenna panel identifier may be reported implicitly, by a physical random access channel (PRACH), or explicitly, in a MAC CE for BFR. For a PRACH-based report, a base station may configure N PRACH resources for a new beam for a UE with N antenna panels. Each PRACH resource may be associated with an antenna panel (e.g., a different antenna panel). The UE can select a PRACH resource, corresponding to a currently used antenna panel, for the new beam to report BFRQ. Alternatively, after BFR, the UE antenna panel can be assumed to be unknown or based on a default antenna panel.

FIG. 3 shows an example method 300 of wireless communication by a base station (e.g., a gNB or eNB), which method 300 may be used to configure and/or receive a beam-to-panel mapping from a UE. The method 300 may be performed by a processor of the base station, and transmissions and receptions initiated by the processor may be made using a transceiver of the base station (e.g., a transceiver including one or multiple antenna panels).

At 302, the method 300 may include receiving a mapping of beams to antenna panels from a UE.

At 304, the method 300 may include explicitly or implicitly acknowledging receipt of the mapping.

Optionally, the method 300 may further include configuring the UE to report the mapping and/or receiving one or more UL transmissions from the UE in accord with the mapping.

The method 300 may be variously configured or modified as described with reference to FIG. 2.

Even when a UE has multiple antenna panels, and multiple active antenna panels, there may be cases where the UE is intended to transmit at least a first UCI in a first PUCCH and a second UCI in a second PUCCH, and the first PUCCH and the second PUCCH may be intended to be transmitted from the same antenna panel with a time domain overlap. There may also be cases where the antenna panel for at least one PUCCH is in an unknown status (e.g., because the UE and a base station are not in an agreement regarding its status). In these cases, legacy UCI multiplexing/dropping rules can be reused. For example, the UE can multiplex the first and second UCIs within the first PUCCH or the second PUCCH, or the UE may drop one of the UCIs/PUCCHs.

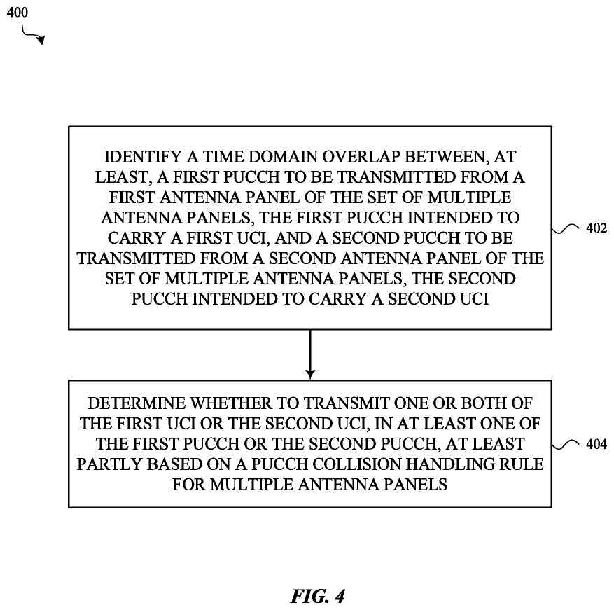

In cases where a UE has multiple antenna panels and the UE is intended to transmit at least a first UCI in a first PUCCH using a first antenna panel, and transmit at least a second UCI in a second PUCCH using a second antenna panel, the UE may perform the method described with reference to FIG. 4 when there is a time domain overlap between the first PUCCH and the second PUCCH.

FIG. 4 shows an example method 400 of wireless communication by a UE, which method 400 may be used to transmit UCI in accord with a PUCCH collision handling rule for multiple antenna panels. The method 400 may be performed by a processor of the UE, and transmissions and receptions initiated by the processor may be made using a set of multiple antenna panels of the UE.

At 402, the method 400 may include identifying a time domain overlap between, at least, a first PUCCH to be transmitted from a first antenna panel of the set of multiple antenna panels, and a second PUCCH to be transmitted from a second antenna panel of the set of multiple antenna panels. The first PUCCH may be intended to carry at least a first UCI. The second PUCCH may be intended to carry at least a second UCI.

At 404, the method 400 may include determining whether to transmit one or both of the first UCI or the second UCI, in at least one of the first PUCCH or the second PUCCH. The determination may be made at least partly based on a PUCCH collision handling rule for multiple antenna panels.

The method 400 may be adapted to accommodate various different scenarios.

In a first scenario, the PUCCH collision handling rule for multiple antenna panels may include determining that the first PUCCH and the second PUCCH are both configured with single-repetition operation. In this scenario, several options are provided for applying the PUCCH collision handling rule for multiple antenna panels.

In accord with a first PUCCH collision handling rule for multiple antenna panels, and under the first scenario, the method 400 may include transmitting the first PUCCH, carrying the first UCI, from the first antenna panel, simultaneously with transmitting the second PUCCH, carrying the second UCI, from the second antenna panel (i.e., transmitting both PUCCHs, despite the time domain overlap). In some cases, an RRC parameter may be introduced to enable this option. In some cases, the UE may report whether it supports this option, as it may require more power consumption and the UE may be configured to not support this option, or may determine not to support this option, if the UE is power constrained (or for other reasons).

In accord with a second PUCCH collision handling rule for multiple antenna panels, and under the first scenario, the method 400 may include determining the first PUCCH and the second PUCCH are both configured with single-repetition operation; determining a UCI dropping condition does not apply to transmission of the first UCI and the second UCI in the first PUCCH; and transmitting the first PUCCH from the first antenna panel, with the first UCI and the second UCI multiplexed in the first PUCCH. Determining that a UCI dropping condition does not apply may include, for example, determining a payload size supported by the first PUCCH supports multiplexing of the first UCI and the second UCI in the first PUCCH, and/or determining that minimum delay requirements for transmitting the first UCI and the second UCI in the first PUCCH are met. If a UCI dropping condition applies to transmission of the first UCI and the second UCI in the first PUCCH, the UE may determine whether a UCI dropping condition applies to transmission of the first UCI and the second UCI in the second PUCCH, and possibly transmit the second PUCCH, with the first UCI and the second UCI multiplexed in the second PUCCH. If a UCI dropping condition prohibits multiplexing the first UCI and the second UCI in either the first PUCCH or the second PUCCH, the second PUCCH collision handling rule may in some cases allow the UE to transmit both PUCCHs without dropping any UCI (e.g., as a fallback).

In accord with a third PUCCH collision handling rule for multiple antenna panels, and under the first scenario, the method 400 may include determining the first PUCCH and the second PUCCH occupy a same time window (i.e., have a same time domain occupancy). Upon determining the first PUCCH and the second PUCCH are scheduled within the same time window, the method 400 may include transmitting the first UCI in the first PUCCH, and transmitting the second UCI in the second PUCCH, at the same time, in at least one of a frequency domain multiplexing (FDM) manner or a spatial domain multiplexing (SDM) manner. Otherwise, if the first PUCCH and the second PUCCH have different time durations or will be transmitted in non-aligned time windows, legacy UCI multiplexing/dropping rules can be reused and only one PUCCH, containing the first UCI, the second UCI, or a multiplexing of the first UCI and the second UCI, may be transmitted.

In accord with a fourth PUCCH collision handling rule for multiple antenna panels, and under the first scenario, the method 400 may include receiving a first multiplexing process indicator for the first PUCCH and a second multiplexing process indicator for the second PUCCH; comparing the first multiplexing process indicator to the second multiplexing process indicator; and determining to transmit one or both of the first UCI or the second UCI, in one or both of the first PUCCH or the second PUCCH, in response to a result of the comparing. In this option, a base station may configure a multiplexing process indicator (e.g., as a target receiving transmission and reception point (TRP) indication) for each PUCCH. When the first and second multiplexing process indicators are the same, legacy UCI multiplexing/dropping rules can be reused and only one PUCCH, containing the first UCI, the second UCI, or a multiplexing of the first UCI and the second UCI, may be transmitted. When the first and second multiplexing process indicators differ, the method 400 may include transmitting the first UCI on the first PUCCH, simultaneously with transmitting the second UCI on the second PUCCH, so long as the first PUCCH and the second PUCCH are associated with different antenna panels. Otherwise (i.e., if the first PUCCH and the second PUCCH are associated with the same antenna panel), the PUCCH carrying the UCI with higher priority may be transmitted.

In accord with a fifth PUCCH collision handling rule for multiple antenna panels, and under the first scenario, the method 400 may include determining whether a transmission power to transmit both the first PUCCH and the second PUCCH exceeds a maximum transmission power of the UE. The method 400 may also include determining to transmit one or both of the first UCI or the second UCI, in one or both of the first PUCCH or the second PUCCH, in response to the determination of whether the transmission power to transmit both the first PUCCH and the second PUCCH exceeds the maximum transmission power of the UE. If the transmission power to transmit both the first PUCCH and the second PUCCH exceeds the maximum transmission power of the UE, then only the first PUCCH or the second PUCCH may be transmitted, based on predefined or configured rules. For example, the rules may allow transmission of the PUCCH that carries the higher priority UCI, and transmission of the other PUCCH may be dropped. Otherwise, if the transmission power to transmit both the first PUCCH and the second PUCCH does not exceed the maximum transmission power of the UE, then both the first PUCCH and the second PUCCH may be transmitted from their respective different antenna panels.

In a second scenario, the method 400 may include identifying an additional time domain overlap between one of the first or second PUCCH transmissions and a third transmission of a third PUCCH. The third PUCCH may be transmitted from the first antenna panel, and may be intended to carry a third UCI. Thus, the second scenario is a hybrid scenario, in which there are time domain overlaps between PUCCH transmissions from the same and different antenna panels. In this scenario, the method 400 may include determining that the first PUCCH, the second PUCCH, and the third PUCCH are all configured with single-repetition operation. If so, the method 400 may further include determining whether to transmit one or both of the first UCI or the third UCI, in at least one of the first PUCCH or the third PUCCH. The determination may be made at least partly based on a PUCCH collision handling rule for a single antenna panel (e.g., in accord with legacy UCI multiplexing/dropping rules). The PUCCH collision handling rule for multiple antenna panels may then be applied after applying the PUCCH collision handling rule for the single antenna panel. The PUCCH collision handling rule for multiple antenna panels may be any of the first through fifth PUCCH collision handling rules described with reference to the first scenario.

In a third scenario, the PUCCH collision handling rule for multiple antenna panels may include determining that at least one of the first PUCCH or the second PUCCH is configured with multiple-repetition operation, without antenna panel switching. In this scenario, different options are provided for applying the PUCCH collision handling rule for multiple antenna panels.

In accord with a first PUCCH collision handling rule for multiple antenna panels, and under the third scenario, the method 400 may include transmitting the first PUCCH, carrying the first UCI, from the first antenna panel, simultaneously with transmitting the second PUCCH, carrying the second UCI, from the second antenna panel (i.e., transmitting both PUCCHs, despite the time domain overlap). In some cases, an RRC parameter may be introduced to enable this option. In some cases, the UE may report whether it supports this option, as it may require more power consumption and the UE may be configured to not support this option, or may determine not to support this option, if the UE is power constrained (or for other reasons).

In accord with a second PUCCH collision handling rule for multiple antenna panels, and under the third scenario, the method 400 may include receiving a first multiplexing process indicator for the first PUCCH and a second multiplexing process indicator for the second PUCCH; comparing the first multiplexing process indicator to the second multiplexing process indicator; and determining to transmit one or both of the first UCI or the second UCI, in one or both of the first PUCCH or the second PUCCH, in response to a result of the comparing. In this option, a base station may configure a multiplexing process indicator (e.g., as a target receiving TRP indication) for each PUCCH. When the first and second multiplexing process indicators are the same, only one PUCCH, containing the first UCI or the second UCI, may be transmitted (e.g., the PUCCH containing the higher priority UCI may be transmitted with the higher priority UCI). When the first and second multiplexing process indicators differ, the method 400 may include transmitting the first UCI on the first PUCCH, simultaneously with transmitting the second UCI on the second PUCCH, so long as the first PUCCH and the second PUCCH are associated with different antenna panels. Otherwise (i.e., if the first PUCCH and the second PUCCH are associated with the same antenna panel), the PUCCH carrying the UCI with higher priority may be transmitted.

In a fourth scenario, the method 400 may include identifying an additional time domain overlap between one of the first or second PUCCH transmissions and a third transmission of a third PUCCH. The third PUCCH may be transmitted from the first antenna panel, and may be intended to carry a third UCI. Thus, the second scenario is a hybrid scenario, in which there are time domain overlaps between PUCCH transmissions from the same and different antenna panels. In this scenario, the method 400 may include determining that at least one of the first PUCCH, the second PUCCH, or the third PUCCH is configured with multiple-repetition operation. If so, the method 400 may further include determining whether to transmit one or both of the first UCI or the third UCI, in at least one of the first PUCCH or the third PUCCH. The determination may be made at least partly based on a PUCCH collision handling rule for a single antenna panel (e.g., in accord with legacy UCI multiplexing/dropping rules). If one of the first PUCCH or third PUCCH is configured with multiple-repetition operation, only one of the first PUCCH or the third PUCCH may be transmitted (e.g., the PUCCH that carries the higher priority UCI). The PUCCH collision handling rule for multiple antenna panels may then be applied after applying the PUCCH collision handling rule for the single antenna panel. The PUCCH collision handling rule for multiple antenna panels may be the first or second PUCCH collision handling rules described with reference to the third scenario.

In some embodiments of the method 400, the UE may have a maximum number of active panels, which maximum number of active antenna panels may be smaller than a maximum number of physical antenna panels. In these embodiments, scenarios may arise in which the number of PUCCHs to be simultaneously transmitted exceeds the maximum number of active antenna panels. In these scenarios, different options are provided for applying the PUCCH collision handling rule for multiple antenna panels.

In accord with a first option for handling a case where the number of PUCCHs to be simultaneously transmitted may exceed the maximum number of active antenna panels, the method 400 may include determining a simultaneous transmission of multiple PUCCHs, including the first PUCCH and the second PUCCH, requires more than a maximum number of active antenna panels selected from the set of multiple antenna panels. The PUCCH collision handling rule for multiple antenna panels may then be applied to the simultaneous transmission of the multiple PUCCHs, and a subset of PUCCHs, selected from the multiple PUCCHs, that is equal to or less than the maximum number of active antenna panels may be transmitted.

In accord with a second option for handling a case where the number of PUCCHs to be simultaneously transmitted may exceed the maximum number of active antenna panels, the method 400 may include determining a simultaneous transmission of multiple PUCCHs, including the first PUCCH and the second PUCCH, requires more than a maximum number of active antenna panels selected from the set of multiple antenna panels. An initial PUCCH collision handling rule may then be applied to a first set of PUCCHs in the multiple PUCCHs. The first set of PUCCHs may be transmitted from one or more lower priority antenna panels. The priorities of antenna panels may be determined by the panel indices for the antenna panels and/or reported beam qualities for the antenna panels. After applying the initial PUCCH collision handling rule to the first set of PUCCHs, the PUCCH collision handling rule for multiple antenna panels may be applied to a second set of PUCCHs in the multiple PUCCHs. The second set of PUCCHs may be the PUCCHs that remain after application of the initial PUCCH collision handling rule. A subset of PUCCHs, selected from the multiple PUCCHs, that is equal to or less than the maximum number of active antenna panels may be transmitted.

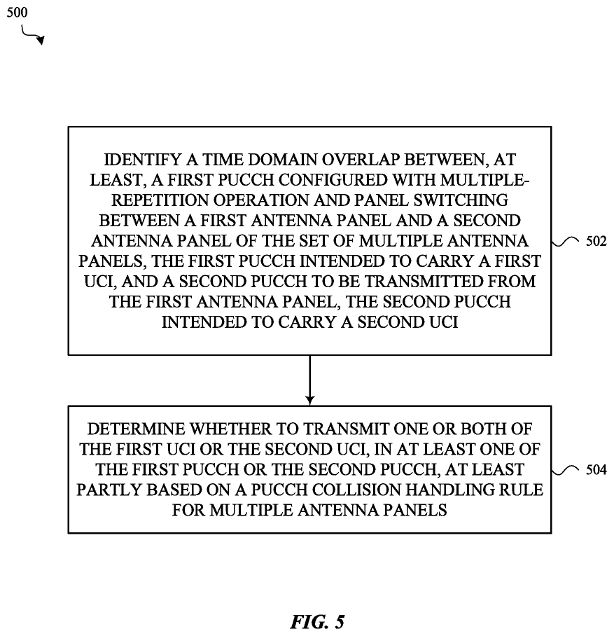

In cases where a UE has multiple antenna panels and the UE is intended to transmit at least a first UCI in a first PUCCH configured with multiple-repetition operation and panel switching (e.g., between a first antenna panel and a second antenna panel), and transmit at least a second UCI in a second PUCCH, using the first antenna panel, the UE may perform the method described with reference to FIG. 5 when there is a time domain overlap between the first PUCCH and the second PUCCH.

FIG. 5 shows an example method 500 of wireless communication by a UE, which method 500 may be used to transmit UCI in accord with a PUCCH collision handling rule for multiple antenna panels. The method 500 may be performed by a processor of the UE, and transmissions and receptions initiated by the processor may be made using a set of multiple antenna panels of the UE.

At 502, the method 500 may include identifying a time domain overlap between, at least, a first PUCCH and a second PUCCH. The first PUCCH may be configured with multiple-repetition operation. The first PUCCH may also be configured with panel switching between a first antenna panel of the multiple antenna panels and a second antenna panel of the multiple antenna panels. The first PUCCH may be intended to carry at least a first UCI. The second PUCCH may be intended to be transmitted from the first antenna panel, and may be intended to carry at least a second UCI.

At 504, the method 500 may include determining whether to transmit one or both of the first UCI or the second UCI, in at least one of the first PUCCH or the second PUCCH. The determination may be made at least partly based on a PUCCH collision handling rule for multiple antenna panels.

In some embodiments, the method 500 may include applying the PUCCH collision handling rule for multiple antenna panels as described with reference to the third scenario of the method described with reference to FIG. 4.

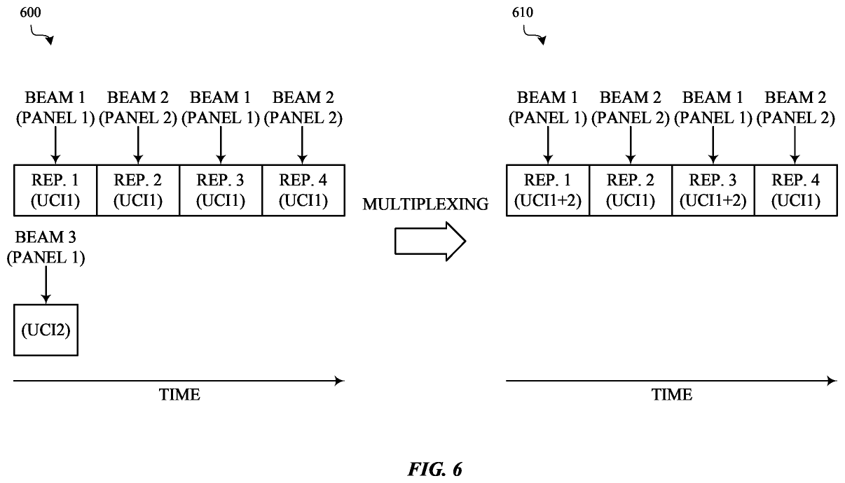

In some embodiments, the method 500 may include transmitting the first PUCCH with repetition from the first antenna panel and the second antenna panel. In these embodiments, the method 500 may also include multiplexing the first UCI and the second UCI only in a first set of repetitions of the first PUCCH transmitted from the first antenna panel, and including the first UCI without the second UCI in a second set of repetitions of the first PUCCH transmitted from the second antenna panel. An example of this embodiment is described with reference to FIG. 6. As shown in the left-hand timeline 600, a first PUCCH is intended to be transmitted, with repetition, from a first panel (Panel 1) using a first beam (Beam 1), and from a second panel (Panel 2) using a second beam (Beam 2), across four cyclic repetitions. The first PUCCH is intended to carry a first UCI. A second PUCCH is intended to be transmitted, without repetition, from the first panel (Panel 1) using a third beam (Beam 3). The second PUCCH is intended to carry a second UCI. After applying the method 500, the first UCI and the second UCI may be multiplexed within a first set of repetitions of the first PUCCH, which repetitions are transmitted from the first panel (Panel 1) using the first beam (Beam 1), as shown in the right-hand timeline 610. The first UCI only may be included in a second set of repetitions of the first PUCCH, which repetitions are transmitted from the second panel (Panel 2) using the second beam (Beam 2).

In some embodiments, the method 500 may include transmitting the first PUCCH with repetition from the first antenna panel and the second antenna panel. In these embodiments, the method 500 may also include multiplexing the first UCI and the second UCI only in a first set of repetitions of the first PUCCH that are intended to be received at a same TRP as the second PUCCH, and including the first UCI without the second UCI in a second set of repetitions of the first PUCCH transmitted from the second antenna panel.

The multiplexing described herein should follow the timeline condition set forth in 3GPP 38.213 § 9.2.5. Otherwise, it may be considered an error case, or a PUCCH may be considered for dropping, or two PUCCHs may be considered for simultaneous transmission from different antenna panels.

In accord with any of the methods described herein, and after determining whether to multiplex or drop UCI in accord with a PUCCH collision handling rule for multiple antenna panels, the UCI(s) that is/are to be transmitted may in some cases be transmitted in PUCCHs transmitted from different antenna panels, to improve reliability. For example, in the context of the method described with reference to FIG. 4, after application of the PUCCH collision handling rule for multiple antenna panels, the method may include transmitting a same singular UCI or combination of UCIs in both the first PUCCH and the second PUCCH. In some cases, the different PUCCHs in which the same singular UCI or combination of UCIs is/are transmitted may need to occupy a same time window (i.e., have the same time domain occupancy) when the PUCCHs overlap.

When a same singular UCI or combination of UCIs is transmitted in more than one PUCCH, for redundancy, the same coding rate may be applied to all of the PUCCHs (i.e., to PUCCHs transmitted from different antenna panels), and the same maximum number of physical resource blocks (PRBs) may be applied to the PUCCHs (i.e., to the PUCCHs transmitted from different antenna panels), and the same actually used number of PRBs may be applied to the PUCCHs (i.e., to the PUCCHs transmitted from different antenna panels). This may enable a 3GPP network (e.g., a base station) to perform soft combining of the redundant UCI transmissions. For PUCCH formats 2/3, when the UCI payload size is not at the maximum capacity, a PRB number adjustment may be made so that a PRB number less than the maximum PRB number is used for PUCCH. Such an adjustment may be performed on a single PUCCH, transmitted from a primary (or reference) antenna panel of a UE. The other PUCCHs, transmitted from other antenna panels, may follow suit.

When a same singular UCI or combination of UCIs is transmitted in more than one PUCCH, for redundancy, a different coding rate may be applied to different PUCCHs (or to each of the PUCCHs) (i.e., to PUCCHs transmitted from different antenna panels), and different maximum numbers of PRBs may be applied to different PUCCHs (or to each of the PUCCHs) (i.e., to the PUCCHs transmitted from different antenna panels), and different actually used numbers of PRBs may be applied to different PUCCHs (or to each of the PUCCHs) (i.e., to the PUCCHs transmitted from different antenna panels). For PUCCH formats 2/3, when the UCI payload size is not at the maximum capacity, a PRB number adjustment may be made so that a PRB number less than the maximum PRB number is used for PUCCH. Such an adjustment may be performed on each PUCCH.

Embodiments contemplated herein include an apparatus having means to perform one or more elements of the method 200, 300, 400, or 500. In the context of method 200, 400, or 500, this apparatus may be, for example, an apparatus of a UE (such as a wireless device 802 that is a UE, as described herein). In the context of method 300, this apparatus may be, for example, an apparatus of a base station (such as a network device 820 that is a base station, as described herein).

Embodiments contemplated herein include one or more non-transitory computer-readable media storing instructions to cause an electronic device, upon execution of the instructions by one or more processors of the electronic device, to perform one or more elements of the method 200, 300, 400, or 500. In the context of method 200, 400, or 500, this non-transitory computer-readable media may be, for example, a memory of a UE (such as a memory 806 of a wireless device 802 that is a UE, as described herein). In the context of method 300, this non-transitory computer-readable media may be, for example, a memory of a base station (such as a memory 824 of a network device 820 that is a base station, as described herein).

Embodiments contemplated herein include an apparatus having logic, modules, or circuitry to perform one or more elements of the method 200, 300, 400, or 500. In the context of method 200, 400, or 500, this apparatus may be, for example, an apparatus of a UE (such as a wireless device 802 that is a UE, as described herein). In the context of method 300, this apparatus may be, for example, an apparatus of a base station (such as a network device 820 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 300, 400, or 500. In the context of method 200, 400, or 500, this apparatus may be, for example, an apparatus of a UE (such as a wireless device 802 that is a UE, as described herein). In the context of the method 300, this apparatus may be, for example, an apparatus of a base station (such as a network device 820 that is a base station, as described herein).

Embodiments contemplated herein include a signal as described in or related to one or more elements of the method 200, 300, 400, or 500.

Embodiments contemplated herein include a computer program or computer program product having instructions, wherein execution of the program by a processor causes the processor to carry out one or more elements of the method 200, 300, 400, or 500. In the context of method 200, 400, or 500, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein). In the context of method 300, the processor may be a processor of a base station (such as a processor(s) 822 of a network device 820 that is a base station, as described herein), and the instructions may be, for example, located in the processor and/or on a memory of the base station (such as a memory 824 of a network device 820 that is a base station, as described herein).

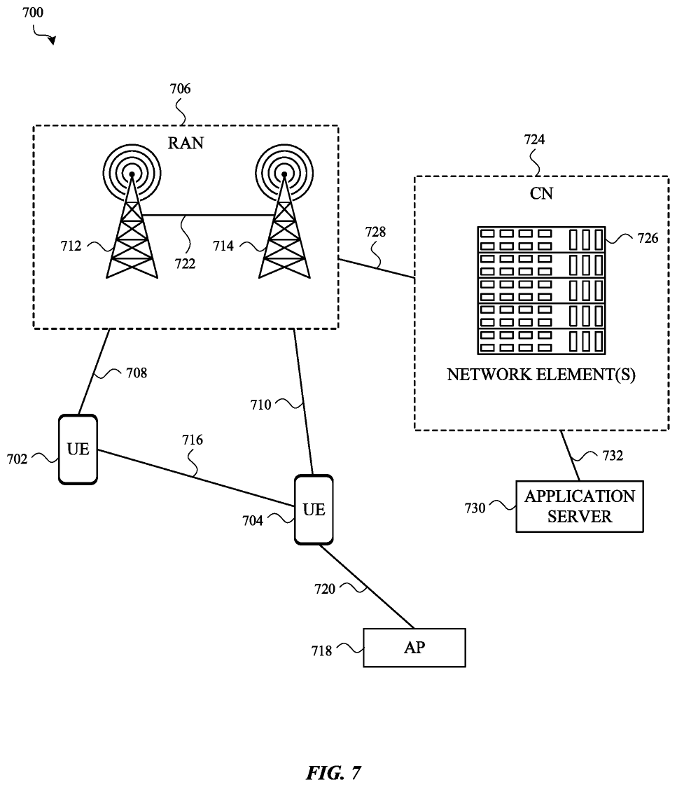

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

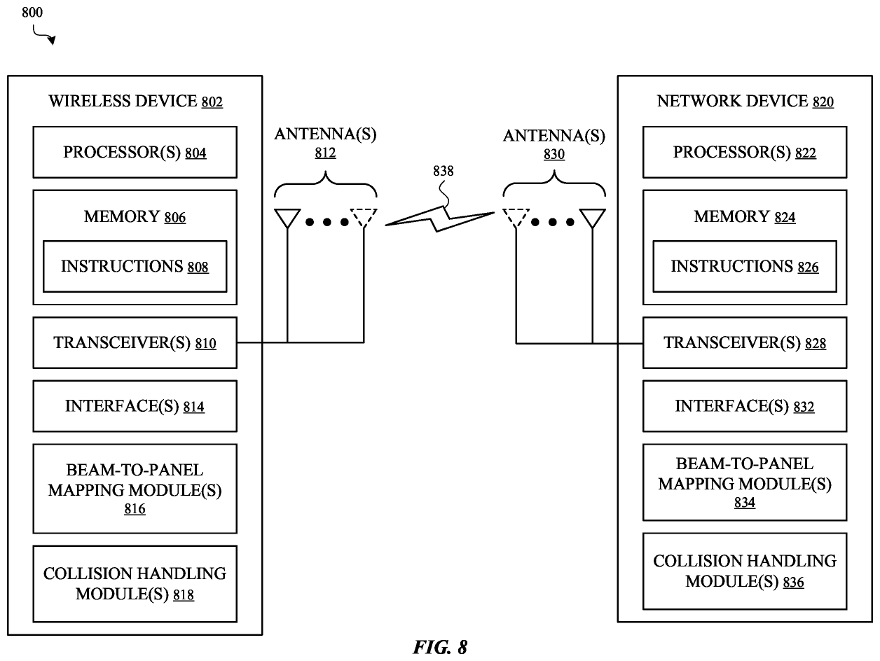

FIG. 8 illustrates a system 800 for performing signaling 838 between a wireless device 802 and a network device 820, according to embodiments disclosed herein. The system 800 may be a portion of a wireless communications system as herein described. The wireless device 802 may be, for example, a UE of a wireless communication system. The network device 820 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a beam-to-panel mapping module 816 and/or a collision handling module 818. The beam-to-panel mapping module 816 and collision handling module 818 may be implemented via hardware, software, or combinations thereof. For example, the beam-to-panel mapping module 816 and collision handling module 818 may be implemented as a processor, circuit, and/or instructions 808 stored in the memory 806 and executed by the processor(s) 804. In some examples, the beam-to-panel mapping module 816 and collision handling module 818 may be integrated within the processor(s) 804 and/or the transceiver(s) 810. For example, the beam-to-panel mapping module 816 and collision handling module 818 may be implemented by a combination of software components (e.g., executed by a DSP or a general processor) and hardware components (e.g., logic gates and circuitry) within the processor(s) 804 or the transceiver(s) 810.

The beam-to-panel mapping module 816 may be used for various aspects of the present disclosure, for example, aspects of FIGS. 1-3. The beam-to-panel mapping module 816 may be configured to, for example, determine and transmit a beam-to-panel mapping to another device (e.g., the network device 820).

The collision handling module 818 may be used for various aspects of the present disclosure, for example, aspects of FIGS. 1 and 4-6. The collision handling module 818 may be configured to, for example, transmit one or more PUCCHs, on one or more beams, in accord with a beam-to-panel mapping and/or other understanding with a base station (e.g., the network device 820), and in accord with one or more PUCCH collision handling rules.

The network device 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

The network device 820 may include a beam-to-panel mapping module 834 and/or a collision handling module 836. The beam-to-panel mapping module 834 and collision handling module 836 may be implemented via hardware, software, or combinations thereof. For example, the beam-to-panel mapping module 834 and collision handling module 836 may be implemented as a processor, circuit, and/or instructions 826 stored in the memory 824 and executed by the processor(s) 822. In some examples, the beam-to-panel mapping module 834 and collision handling module 836 may be integrated within the processor(s) 822 and/or the transceiver(s) 828. For example, the beam-to-panel mapping module 834 and collision handling module 836 may be implemented by a combination of software components (e.g., executed by a DSP or a general processor) and hardware components (e.g., logic gates and circuitry) within the processor(s) 822 or the transceiver(s) 828.

The beam-to-panel mapping module 834 may be used for various aspects of the present disclosure, for example, aspects of FIGS. 1-3. The beam-to-panel mapping module 834 may be configured to, for example, configure and/or receive a beam-to-panel mapping by/from another device (e.g., the wireless device 802).

The collision handling module 836 may be used for various aspects of the present disclosure, for example, aspects of FIGS. 1 and 4-6. The collision handling module 836 may be configured to, for example, receive one or more PUCCHs, on one or more beams, in accord with beam-to-panel mapping and/or other understandings with a UE (e.g., the wireless device 802).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a set of multiple antenna panels; and
a processor configured to,
identify a time domain overlap between at least,
a first physical uplink control channel (PUCCH) to be transmitted from a first antenna panel of the set of multiple antenna panels, the first PUCCH intended to carry a first uplink control information (UCI); and
a second PUCCH to be transmitted from a second antenna panel of the set of multiple antenna panels, the second PUCCH intended to carry a second UCI; and
determine whether to transmit one or both of the first UCI or the second UCI, in at least one of the first PUCCH or the second PUCCH, at least partly based on a PUCCH collision handling rule for multiple antenna panels. 2 The UE of claim 1, wherein:
the processor is configured to,
transmit the first PUCCH, carrying the first UCI, from the first antenna panel; and
simultaneous with transmission of the first PUCCH, transmit the second PUCCH, carrying the second UCI, from the second antenna panel.

3. The UE of claim 1, wherein:
the processor is configured to,
determine the first PUCCH and the second PUCCH are both configured with single-repetition operation;
determine a UCI dropping condition does not apply to transmission of the first UCI and the second UCI in the first PUCCH; and
transmit the first PUCCH from the first antenna panel, with the first UCI and the second UCI multiplexed in the first PUCCH.

4. The UE of claim 1, wherein:
the processor is configured to,
determine the first PUCCH and the second PUCCH are both configured with single-repetition operation;
determine the first PUCCH and the second PUCCH occupy a same time window; and
transmit the first UCI in the first PUCCH, and transmit the second UCI in the second PUCCH, at a same time, in at least one of a frequency domain multiplexing (FDM) manner or a spatial domain multiplexing (SDM) manner.

5. The UE of claim 1, wherein:
the processor is configured to,
receive a first multiplexing process indicator for the first PUCCH and a second multiplexing process indicator for the second PUCCH;
compare the first multiplexing process indicator to the second multiplexing process indicator; and
determine to transmit one or both of the first UCI or the second UCI, in one or both of the first PUCCH or the second PUCCH, in response to a result of the comparison.

6. The UE of claim 1, wherein:
the processor is configured to,
determine the first PUCCH and the second PUCCH are both configured with single-repetition operation;
determine whether a transmission power to transmit both the first PUCCH and the second PUCCH exceeds a maximum transmission power of the UE; and
determine to transmit one or both of the first UCI or the second UCI, in one or both of the first PUCCH or the second PUCCH, in response to the determination of whether the transmission power to transmit both the first PUCCH and the second PUCCH exceeds the maximum transmission power of the UE.

7. The UE of claim 1, wherein:
the processor is configured to,
identify an additional time domain overlap between,
a third transmission of a third PUCCH, the third PUCCH transmitted from the first antenna panel, and the third PUCCH intended to carry a third UCI; and
at least one of the first transmission of the first PUCCH and the second transmission of the second PUCCH;
determine whether to transmit one or both of the first UCI or the third UCI, in at least one of the first PUCCH or the third PUCCH, the determination made at least partly based on a PUCCH collision handling rule for a single antenna panel; and
apply the PUCCH collision handling rule for multiple antenna panels after applying the PUCCH collision handling rule for the single antenna panel.

8. The UE of claim 1, wherein:
the processor is configured to,
determine a simultaneous transmission of multiple PUCCHs, including the first PUCCH and the second PUCCH, requires more than a maximum number of active antenna panels selected from the set of multiple antenna panels;
apply the PUCCH collision handling rule for multiple antenna panels to the simultaneous transmission of the multiple PUCCHs; and
transmit a subset of PUCCHs, selected from the multiple PUCCHs, that is equal to or less than the maximum number of active antenna panels.

9. The UE of claim 1, wherein:
the processor is configured to,
determine a simultaneous transmission of multiple PUCCHs, including the first PUCCH and the second PUCCH, requires more than a maximum number of active antenna panels selected from the set of multiple antenna panels;
apply an initial PUCCH collision handling rule to a first set of PUCCHs in the multiple PUCCHs, the first set of PUCCHs transmitted from one or more lower priority antenna panels;
apply the PUCCH collision handling rule for multiple antenna panels to a second set of PUCCHs in the multiple PUCCHs, the second set of PUCCHs remaining after application of the initial PUCCH collision handling rule; and
transmit a subset of PUCCHs, selected from the multiple PUCCHs, that is equal to or less than the maximum number of active antenna panels.

10. The UE of claim 1, wherein the processor is configured to, after application of the PUCCH collision handling rule for multiple antenna panels, transmit a same singular UCI or combination of UCIs in both the first PUCCH and the second PUCCH.

11. The UE of claim 10, wherein:
the processor is configured to determine the first PUCCH and the second PUCCH occupy a same time window; and
the same singular UCI or combination of UCIs is transmitted in both the first PUCCH and the second PUCCH at least partly based on the first PUCCH and the second PUCCH occupying the same time window.

12. The UE of claim 10, wherein:
the processor is configured to,
apply a same coding rate to the first PUCCH and the second PUCCH;
apply a same maximum number of physical resource blocks (PRBs) to the first PUCCH and the second PUCCH; and
apply a same actually used number of PRBs to the first PUCCH and the second PUCCH.

13. The UE of claim 10, wherein:
the processor is configured to,
apply a different coding rate to each of the first PUCCH and the second PUCCH;
apply a different maximum number of physical resource blocks (PRBs) to each of the first PUCCH and the second PUCCH; and
apply a different actually used number of PRBs to each of the first PUCCH and the second PUCCH.

14. A user equipment (UE), comprising:
a set of multiple antenna panels; and
a processor configured to,
identify a time domain overlap between at least,
a first physical uplink control channel (PUCCH) configured with multiple-repetition operationand panel switching between a first antenna panel and a second antenna panel of the set of multiple antenna panels, the first PUCCH intended to carry a first uplink control information (UCI); and
a second PUCCH to be transmitted from the first antenna panel, the second PUCCH intended to carry a second UCI; and
determine whether to transmit one or both of the first UCI or the second UCI, in at least one of the first PUCCH or the second PUCCH, at least partly based on a PUCCH collision handling rule for multiple antenna panels.

15. The UE of claim 14, wherein:
the processor is configured to,
transmit the first PUCCH with repetition, from the first antenna panel and the second antenna panel;
multiplex the first UCI and the second UCI only in a first set of repetitions of the first PUCCH transmitted from the first antenna panel; and
include the first UCI without the second UCI in a second set of repetitions of the first PUCCH transmitted from the second antenna panel.

16. The UE of claim 14, wherein:
the processor is configured to,
transmit the first PUCCH with repetition, from the first antenna panel and the second antenna panel;
multiplex the first UCI and the second UCI only in a first set of repetitions of the first PUCCH that are intended to be received at a same transmission and reception point (TRP) as the second PUCCH; and
include the first UCI without the second UCI in a second set of repetitions of the first PUCCH transmitted from the second antenna panel.

17. A user equipment (UE), comprising:
a set of multiple antenna panels; and
a processor configured to,
determine a mapping of beams to antenna panels of the set of multiple antenna panels; and
transmit the mapping to a 3GPP network using at least one antenna panel in the set of multiple antenna panels.

18. The UE of claim 17, wherein:
the processor is configured to receive, from the 3rd generation partnership project (3GPP) network and via at least one antenna panel in the set of multiple antenna panels, a configuration to report an antenna panel identifier for a respective antenna panel, of the set of multiple antenna panels, used for each of one or more beams or groups of beams, the one or more beams or groups of beams used for a set of configured synchronization signal block (SSB) or channel state information reference signal (CSI-RS) resources; and
the mapping of the beams to the antenna panels includes the antenna panel identifier for the respective antenna panel used by the UE for each of the one or more beams or groups of beams.

19. The UE of claim 18, wherein the mapping of the beams to the antenna panels is transmitted in uplink control information (UCI) or in a medium access control (MAC) control element (CE) (MAC CE).

20. The UE of claim 17, wherein:
the processor is configured to include, in the mapping, an antenna panel identifier for a respective antenna panel used by the UE for each of one or more activated transmission configuration indicator (TCI) states or each of one or more indicated TCI states; and
the mapping of the beams to the antenna panels includes the antenna panel identifier for the respective antenna panel used by the UE for each of the one or more activated TCI states or each of the one or more indicated TCI states.
